(19) United States
(12) Patent Application Publication
(10) Pub. No.: US 2026/0169747 A1
(43) Pub. Date: Jun. 18, 2026

(54) TABLE OF COMMON REGISTER VALUES FOR LOWER-COST INJECTION OF PREDICTED DATA VALUES INTO THE PROCESSOR CORE

(71) Applicant: Intel Corporation, Santa Clara, CA (US)

(72) Inventors: Rafael TRAPANI POSSIGNOLO, Hillsboro, OR (US); Henry WONG, Hillsboro, OR (US); Rohan SHARMA, Hillsboro, OR (US); Ricardo Daniel QUEIROS ALVES, Hillsboro, OR (US); Meenakshi MARATHE, Hillsboro, OR (US)

(73) Assignee: Intel Corporation, Santa Clara, CA (US)

(21) Appl. No.: 18/981,431

(22) Filed: Dec. 13, 2024

(51) Int. Cl. G06F 9/38; G06F 9/30

(52) U.S. Cl. CPC G06F 9/3806; G06F 9/30043

(57) ABSTRACT

Techniques for a processor, method and system to implement a table of common register values for lower-cost injection of predicted data values into the processor core. A storage unit contains M entries with each entry of the M entries capable of holding a data value having a bit length n and the M entries are indexed to be accessed by m number of bits, where m<n. A value prediction circuitry performs value prediction on an instruction by selection of an entry from the M entries by an entry index of m-bits and use the entry index to perform the value prediction, instead of using a corresponding data value stored at the entry.

### BACKGROUND

Some optimizations in a processor involve injecting known or predicted register values into a processor core for use by source operands of instructions. One example is value prediction, where a predictor predicts the result of a load or arithmetic operation, and wants to inject this predicted value into the processor for use by consumers of the load or arithmetic operation, without waiting for the load or arithmetic operation to complete, thereby improving performance.

Register values are typically big (e.g., 64 bits) and are expensive to store in a predictor. It is also expensive to route a large number of these big values from the predictor to the register file or Arithmetic Logic Unit (ALU) where the values are ultimately consumed.

Many algorithms that require injection of values tend to repeatedly inject a small set of unique values, and these values are not necessarily known until runtime (e.g., pointer values). This tends to be true because easy-to-predict values are often the repeating values.

For many prediction algorithms, the most natural implementation would be to store the predicted values directly in the predictor. It then copies those values from the predictor in the front-end into the register file, such as by performing the equivalent of a “move immediate value to register” micro-operation (micro-op). This works, but is more expensive due to the movement of large numbers of bits.

### BRIEF DESCRIPTION OF DRAWINGS

Various examples in accordance with the present disclosure will be described with reference to the drawings, in which:

FIG. 1 illustrates an example of a storage unit used as a dictionary in which a number of entries are used to store data values in the dictionary according to some examples of the disclosure.

FIG. 2 illustrates an example of how a value predictor uses the dictionary identifier, instead of the data value stored in the dictionary, to perform value prediction according to some examples of the disclosure.

FIG. 3 shows a processor utilizing a value predictor according to some examples of the disclosure.

FIG. 4 is a state diagram showing the lifetime of each entry in the dictionary according to some examples of the disclosure.

FIG. 5 shows a flow chart illustrating an operation of a dictionary entry reclaim procedure according to some examples of the disclosure.

FIG. 6 shows a flow chart showing a method of using the dictionary to perform value prediction according to some examples of the disclosure.

FIG. 7 illustrates an example computing system.

FIG. 8 illustrates a block diagram of an example processor and/or System on a Chip (SoC) that may have one or more cores and an integrated memory controller.

FIG. 9(A) is a block diagram illustrating both an example in-order pipeline and an example register renaming, out-of-order issue/execution pipeline according to examples.

FIG. 9(B) is a block diagram illustrating both an example in-order architecture core and an example register renaming, out-of-order issue/execution architecture core to be included in a processor according to examples.

FIG. 10 illustrates examples of execution unit(s) circuitry, such as execution unit(s) circuitry.

FIG. 11 is a block diagram of a register architecture according to some examples.

FIG. 12 illustrates examples of an instruction format.

FIG. 13 illustrates examples of an addressing information field.

### DETAILED DESCRIPTION

In the following description, for the purposes of explanation, numerous specific details are set forth in order to provide a thorough understanding of the disclosure. It will be apparent, however, to one skilled in the art that the examples described may be practiced without some of these specific details. In other instances, well-known structures and devices are shown in block diagram form to avoid obscuring the underlying principles of the examples described.

The present disclosure relates to methods, apparatus and systems for a table of common register values for lower-cost injection of predicted data values into the processor core. According to some examples, this disclosure describes a way to inject values into a processor by maintaining a table of commonly used values (e.g., next to a register file near ALU(s)), and using indexes into this smaller table throughout most of the processor to represent values instead of the full bit value (e.g., 64-bit value), thereby reducing cost. The disclosure includes mechanisms to install and remove values from the table without incurring expensive pipeline flushes while still ensuring correct operation of the out-of-order processor to perform our-of-order operations.

The disclosure describes examples to maintain a table of commonly used values to reduce the cost of value-prediction-like algorithms, which can use an index into the table (˜4-8 bits, depending on table size) instead of full values, such as 64-bit values. Maintaining this table requires methods to correctly install and remove values from the table without needing to incur stalls or expensive pipeline flushes. This technique allows value prediction in a processor (e.g., processor core) to be performed at lower cost with less bits than using full length data values.

The disclosure describes a table of commonly used register values (which is referred to as a “dictionary” herein). The dictionary is a storage that contains data values used by registers, execution units, processor cores, etc. In an example described herein, the dictionary is a storage unit associated with storing values used in operations pertaining to value prediction. The disclosure also describes a method to use, install, and reclaim entries in the dictionary in regard to a prediction algorithm that predicts register values (e.g., load value prediction).

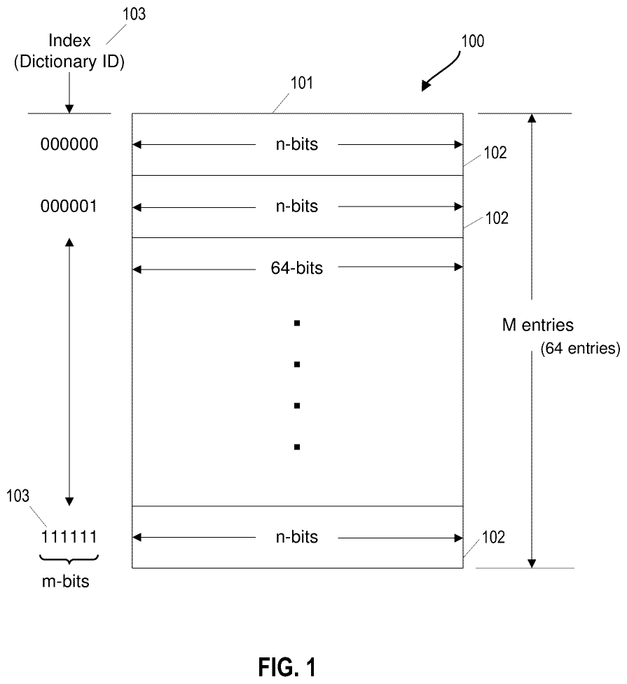

FIG. 1 illustrates an example of a storage unit used as a dictionary in which a number of entries are used to store data values in the dictionary according to some examples of the disclosure. A storage unit 100 contains storage, such as memory storage, which can be configured into a variety of data structures, such as a table. Hence, the storage unit 100 is referred to as dictionary (or dictionary table) 101 in the disclosure.

The dictionary 101 contains M number of entries, each of which can hold a register value (or data value). Thus, FIG. 1 shows the dictionary 101 with M number of entries 102 to store the data values. M can be of any number; however, the example of FIG. 1 has 64 entries (M=64). Each entry 102 stores a data value of n-bits. “n” can be of any number, but the example of FIG. 1 shows each entry 102 capable of storing a data value of 64-bits (n=64). In instances where a register uses 64-bits, the 64-bit data value can be a register value. Furthermore, the stored data values can be variable, fixed, or a combination of fixed and variable.

Each entry 102 is indexed by an index value or index number to provide an entry identifier, which index identifier is shown as dictionary identifier (ID) 103. Thus, each entry 102 has a corresponding dictionary ID 103. The dictionary 101 uses “m” number of bits to uniquely index each corresponding entry 102. “m” can be of any number (e.g., ˜4-8 bits). However, because the example dictionary 101 shown uses 64 entries, 6-bits (m=6 ) allow for indexing to the 64 entries (26=64), such that a particular dictionary ID 103 corresponds to a stored data value.

As will be described below for value prediction, the dictionary 101 operates as a table that uses indices as an indirection value for the data values stored in the entries 102, in which the bit length of the dictionary ID 103 is smaller than the bit length of the data value (m<n). In the example, “m” is 6 and “n” is 64. The prediction algorithms use the index (e.g., dictionary ID 103) into this table (6 bits) in most places of the machine, except for places where it actually needs to use the full 64-bit data value (e.g., where operation needs to verify if the predicted value was correct). That is, the value prediction operation (e.g., algorithm) uses the shorter length dictionary ID 103, instead of the longer-length data values stored in the entries 102.

The value in each dictionary entry 102 is trained by a prediction and training logic when it thinks the value will be useful. However, it may also contain fixed entries (e.g., 0 or 1) for values known to be common across most workloads. One reason for having both types of entries is because some values are always common (0, 1), while others are only known at runtime (e.g., pointers to static data structures) even if they rarely change. As an example, the M number entries 102 may have two fixed entries (0 and 1) and sixty-two variable entries.

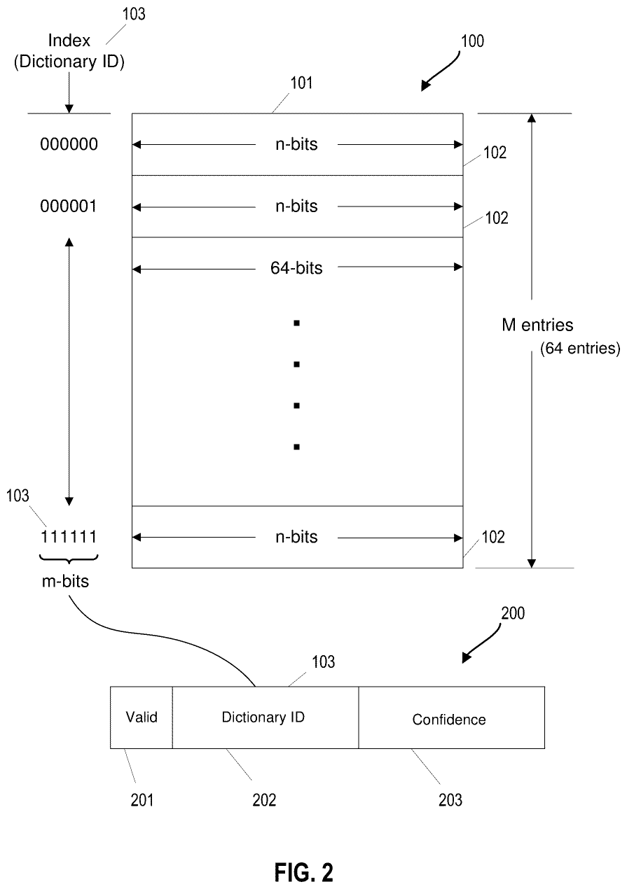

FIG. 2 illustrates an example of how a value predictor uses the dictionary identifier, instead of the data value stored in the dictionary, to perform value prediction according to some examples of the disclosure. This technique can result in a reduction of cost in implementing and using a value predictor, because significantly less bits are used for value prediction.

A value predictor uses the 6-bit value instead of the 64-bit value for value prediction, except where the 64-bit data value is required. Hence, less bits and/or lines are needed to perform value prediction. Predicted values generally come from a predictor (in front-end of the processor), attached to micro-ops, and are sent to many places in the processor. These signals now become 6 bits instead of 64 bits.

The dictionary 101 has fewer entries compared to other value predictor tables known in the art. Having fewer entries 102 enable the value predictor to predict a substantial number of different load instructions without storing all of the 64-bit values of the instructions, provided those loads use a set of limited number of common unique values, which can be stored in the dictionary 101. It allows the value predictor table (number of load instructions for which one can make a prediction) to grow independently of the dictionary table (number of unique values that can be predicted).

The technique is workable because full values are not needed everywhere in the processing cycle. Much of the early part of the pipeline (e.g., value predictor, renaming stage, etc.) does not need the full 64-bit predicted values at all. This puts the full 64-bit value storage closer to where they're needed and reduces the amount of copying of large values around the processor core. Thus, when using the dictionary 101, the load value prediction table entries uses the 6-bit dictionary ID 103. FIG. 2 shows one prediction table entry 200 of a load prediction table where a dictionary ID 103 is inserted for the data field 202 for value prediction instead of the 64-bit data value. In some examples, other fields are also present, such as a valid field 201 and confidence field 203. The valid field 201 indicates if the prediction table entry 200 is valid or invalid. The confidence field 203 indicates a confidence value of the value prediction. As an example, valid field 201 can be one bit, field 202 can be six bits, and the confidence field three bits. Other prediction table entries 200 can use different number of bits, as well as other fields, and need not be limited to the illustrated example. Each prediction table entry 200 operates as an index and maps to a particular data value entry 102. Therefore, using an indirection table of common values to avoid storing full values for value prediction can reduce cost in an out-of-order processor.

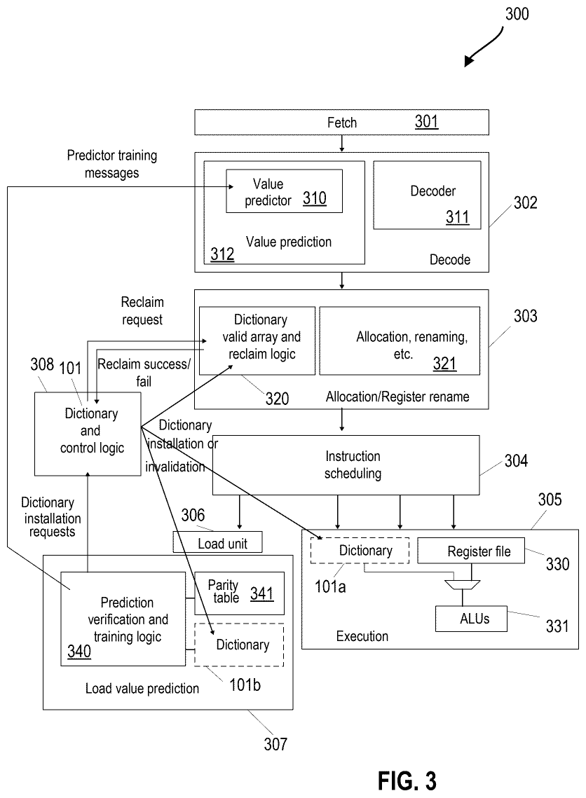

FIG. 3 shows a processor utilizing a value predictor according to some examples of the disclosure. FIG. 3 shows a processor 300 and, in particular, a portion of a pipeline of the processor 300 pertaining to the use of value prediction for out-of-order processing. The processor 300 diagram shows a fetch unit 301, decode unit 302, allocation/register rename unit 303, instruction scheduling unit 304, execution unit 305, load unit 306 and a load value prediction unit 307, along with a dictionary and control logic unit 308. The earlier described dictionary 101 is part of the dictionary and control logic unit 308. The various units pertain to the pipeline operation of the processor 300, so that the units may be regarded as stages of a processing pipeline.

A value predictor (or some other kind of predictor) 310 in a value prediction logic 312 makes a prediction that a particular instruction's result will be the value of a particular dictionary entry, and the instruction will write this result into a logical register (e.g., “rax”). The predictor itself doesn't need to know the exact value, it only needs to know which dictionary entry holds the predicted value. A decoder 311 is incorporated in the decode unit 302 to provide decoding of instructions.

A dictionary valid array and reclaim logic 320 in the allocation/register rename stage contains one bit per dictionary entry indicating whether that entry is valid and has been loaded with a value. (Fixed entries like 0 or 1 always have the valid bit set to valid, which is “1” in this example). This valid bit is shown in the valid field 201 in FIG. 2. The valid bit is used to ensure correctness of the data in the data filed 202. In some examples, the dictionary valid array and reclaim logic 320 contains a copy of the states of the dictionary entries (valid/invalid/pending_reclaim), but without the 64-bit data. Since the dictionary valid array and reclaim logic 320 receives messages notifying installation and invalidation, it has knowledge of the state of each dictionary entry.

If the value predictor 310 tries to make a prediction that uses a dictionary entry that is not valid, the dictionary valid array and reclaim logic 320 prevents the entry from being used by suppressing the prediction. If the prediction valid bit shows valid, an allocation/renaming stage 321 maps the corresponding logical register to the predicted dictionary entry. Once a dictionary entry 102 is in use, its value does not change until all potential users no longer use it.

The dictionary 101 in the dictionary and control logic unit 308 behaves like an extension to a physical register file. The allocation/renaming stage 321 renames logical registers into physical registers or dictionary entries.

Instructions whose source operands use a logical register that is mapped to the dictionary 101 will obtain its value from the dictionary 101 instead of from a register file 330 during execution of the instruction in the execution unit 305. One or more Arithmetic Logic Unit(s) 331 provide the execution of the instruction. Thus, the execution stage of the processor needs the dictionary 101 (or a copy of the dictionary 101a and/or 101b) to obtain the data value stored in the entry 201 corresponding to the dictionary ID used when mapped to the dictionary 101. Although the execution stage 305 can access the dictionary 101 in the dictionary and control logic unit 308, in some examples a duplicate copy of the dictionary can be located near the register file 330 to maintain proximity for access by the ALUs 331. That distance can match the distance between the register file 330 and the ALUs 331 to maintain similar transfer time delay. This duplicate copy of the dictionary 101 is shown as dictionary copy 101a. The execution unit 305 contains hardware that reads source operands as well as the ability to read the dictionary 101a (or 101 if a duplicate copy 101a is not employed).

When used for load value prediction by load unit 306, the load unit contains hardware required to verify the correctness of the load prediction, and that hardware also needs access to the dictionary 101 to have data values to verify against the load value. As noted with the execution unit 305, a separate copy of the dictionary 101 can be placed near the load unit 306, instead of using the dictionary 101 in the dictionary and control logic unit 308.

In order to perform predictor training, the load value prediction unit 307 incorporates a prediction verification and training logic 340. For a load value predictor, there is an indexed parity table 341 to detect potential candidates for installing entries into the dictionary 101. In some implementations, a duplicate dictionary copy 101b (similar to copy 101a) is included within the load value prediction unit 307 for proximity access by the prediction verification and training logic 340. In some instances, the load unit 306 can access the dictionary copy 101b, instead of dictionary 101. In some examples, copies of the dictionary can include a valid bit per entry as well, where these duplicate detection needs to know which entries are valid.

A variety of prediction verification training techniques can be used for load value prediction, including techniques known in the art. Essentially, the training logic determines if an instruction appears to produce the same value repeatedly. If so, the prediction verification and training logic 340 takes the load value and installs it into the dictionary 101, then observes for a while longer to ensure it really is predictable. A confidence value of the prediction is then generated or updated, and placed in the confidence field 203. Once this training is accomplished, the value predictor 310 then begins predicting that the load produces the value of the dictionary entry that contains the predicted value. However, as noted above, the index value (e.g., dictionary ID 103) of prediction table entry 200 is used for the value prediction, instead of the actual data value, now stored in a corresponding entry 102. Furthermore, in some examples, other applications could use their own training algorithms, where the objective of training is to detect useful values and install them into the dictionary, while also avoiding installing non-useful values.

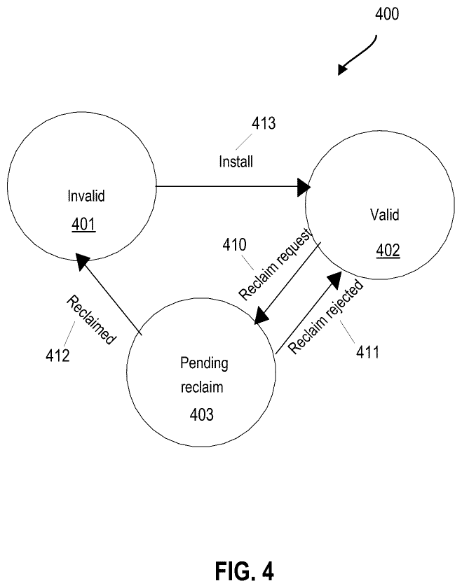

FIG. 4 is a state diagram showing the lifetime of each entry 201 in the dictionary 101 according to some examples of the disclosure. FIG. 4 shows a state diagram 400 having three states: Invalid state 401, Valid state 402 and a Pending Reclaim state 403. Invalid state 401 indicates that the corresponding dictionary entry 200 does not have a valid value and cannot be used for value prediction. The bit in the valid field 201 for an entry 200 is set to “0” to indicate that the particular entry 200 is invalid. When a new value is installed 413 into the particular entry 200, it becomes valid and the valid bit 201 is set to “1” (indicating that the entry is valid). When the particular dictionary entry 200 has a valid value, The entry's data value (e.g., 64-bit value) is not to change until the state becomes Invalid again.

To remove an entered valid value from an entry location in the dictionary to reclaim that entry location, a reclaim request is made to transition 410 to the Pending Reclaim state 403. In the Pending Reclaim state 403, a decision is made to accept 412 the reclaim request and transition the prediction table entry 200 to the Invalid state 401 to reclaim the entry, or reject 411 the reclaim request and maintain the Valid state 402.

While in the Pending Reclaim state 403, the prediction table entry 200 is disallowed from being used by any new predictions, while hardware checks/waits until all potential users of the entry no longer exist. Once it can guarantee that there are no more users, the reclaim can succeed and the entry becomes Invalid (Invalid state 401). But, as noted above, if there is an active user of the dictionary entry, the reclaim request can be rejected and the entry remains in the Valid state 402.

The state diagram 400 describes operations performed between the dictionary and control logic 308 and the dictionary valid array and reclaim logic 320 of FIG. 3. The dictionary and control logic 308 maintains the dictionary 101, as well as the Valid and Invalid states for each entry of the dictionary. The dictionary valid array and reclaim logic 320 may also maintain the Valid and Invalid state of each entry or receive the Valid and Invalid state of an entry from the dictionary and control logic 308. The dictionary and control logic 308 sends the reclaim request to the dictionary valid array and reclaim logic 320. The dictionary valid array and reclaim logic 320 performs operations earlier described pertaining to the Pending Reclaim state 403 and responds by either accepting 412 (success) or rejecting 411 (fail) the reclaim request.

When the prediction algorithm of the prediction verification and training logic 340 wants to install a new value into the dictionary 101, the dictionary is first associatively searched to ensure the value doesn't already exist in the dictionary. Duplicate values are disallowed to keep the number of M entries small. If it is in the dictionary, reuse the entry. Otherwise allocate a free entry (any entry in the Invalid state) and set the entry to hold the desired value. The dictionary and control logic 308 broadcasts the installation message to all copies (e.g., 101a, 101b) of the dictionary in the processor 300 to keep them all synchronized. It is not necessary for all dictionary copies in the processor to be updated at the same time, however, all copies should be updated before the allocation/register rename unit 303 can allow a newly installed entry to be used. All dictionary copies should observe the same updates in the same order.

The prediction verification and training logic 340 also provides predictor training messages to the value predictor 310 in order to perform value prediction. The value prediction is based on the index indicated by the dictionary ID instead of by the full data value.

Removing a dictionary entry is more complicated than installing. In order to remove a dictionary entry from the dictionary 101, the processor 300 checks to ensure that all parts of the processor core have stopped using (and will never again use) a dictionary entry before that dictionary entry 101 can be removed. The process of removing an entry is fairly slow, so in some examples, the dictionary and control logic 308 attempts to maintain a small number of free (e.g., Invalid state) dictionary entries, and sends a reclamation requests for the least valuable entry or entries (e.g., least recently used entry/entries) when a number of free entries drops below the threshold number. In some examples, the dictionary and control logic 308 uses a threshold number of “4” so that when there are less than 4 free entries available, the dictionary and control logic 308 sends the reclaim request.

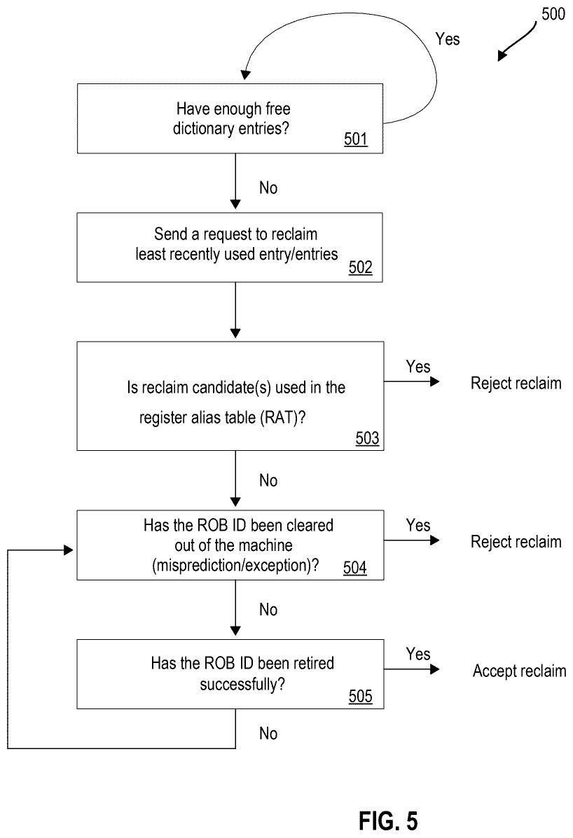

FIG. 5 shows a flow chart illustrating an operation of a dictionary entry reclaim procedure according to some examples of the disclosure. The flow chart of FIG. 5 shows a method (or process) 500 in which the dictionary and control logic 308 performs the first two operations 501 and 502, and the dictionary valid array and reclaim logic 320 performs the last three operations. In operation 501, the dictionary and control logic 308 looks to determine if any entry, or entries when maintaining a threshold level of available entries as described above, are available (e.g., having the Invalid state) for a new value, such as when there is a new dictionary entry installation from the prediction verification and training logic 340. If yes, the available entry is used. If no, a reclaim request is sent, as shown for operation 502, to the dictionary valid array and reclaim logic 320.

Most of the reclamation process is handled by the register allocation/register rename stage 303, because it involves searching the register rename mapping, such as a Register Alias Table (RAT). When a request to reclaim a particular dictionary entry arrives at the dictionary valid array and reclaim logic 320, the logic ensures that the dictionary entry is no longer used by any part of the processor 300 before the reclaim is permitted.

As shown in operation 503, the RAT is associatively searched to see whether any RAT entries map a logical register to a dictionary ID (hence, dictionary entry) being reclaimed. If the RAT has an entry that points to the dictionary ID, then that logical register is using the dictionary entry. If this happens, it is unknown if or how long it will take before that logical register will be overwritten with a new value, so the reclaim request is rejected because the dictionary entry is still in use.

If the RAT search finds no entries matching the dictionary ID being reclaimed, then at about the same time as the RAT search, the dictionary entry transitions to Pending Reclaim state to stop any new micro-operations (micro-ops) coming from the decode unit 302 from using the dictionary entry in the future.

At this point, the processor knows that the dictionary entry is not used at or after the point in the program at which point the RAT search was conducted, but it is still possible for micro-ops before this point to still be using the dictionary entry. To ensure that nothing is using the dictionary entry, the process waits until all micro-ops before the RAT search point successfully retire (and leave the processor) before declaring the reclaim successful.

However, if a pipeline flush rolls back the instruction stream to a point in the program earlier than when the RAT search was conducted, there is no longer a guarantee that the RAT search performed in operation 503 is correct. Therefore, in operation 503, the dictionary valid array and reclaim logic 320 records the point in the program, such as by use of a ReOrder Buffer Identity (ROB ID) at which the RAT search was performed. The ROB ID is checked at operation 504. If the ROB ID has been cleared (such as by an occurrence of a misprediction or exception), then the reclaim is rejected. If the ROB ID has not been cleared, operation 505 waits until it is either retired successfully to accept the reclaim request, or flushed/discarded out of the processor (reject the reclaim), as shown in operation 504.

Although the reclaim process can be slow, the procedure does not cause delays to the instructions in the processor 300, since the reclamation process 500 does not cause stalls or pipeline flushes. The reclaim process does not actually limit the rate at which dictionary entries (dictionary ID) can be reclaimed because multiple reclaims can be inflight at the same time.

At times, it is useful to remove all entries from the dictionary at the same time (e.g., flushing the dictionary), such as when crossing isolation domains to prevent any knowledge of dictionary contents from crossing the boundary. This is implemented by adding a new “disabled” state bit to each prediction table entry 200, which causes the entry to be treated as if it were Invalid, except that it must first be reclaimed before it can be reused to hold a new value. This mechanism implements the effect of instantaneously removing every entry from the dictionary without needing to instantaneously check whether all affected entries are still in use.

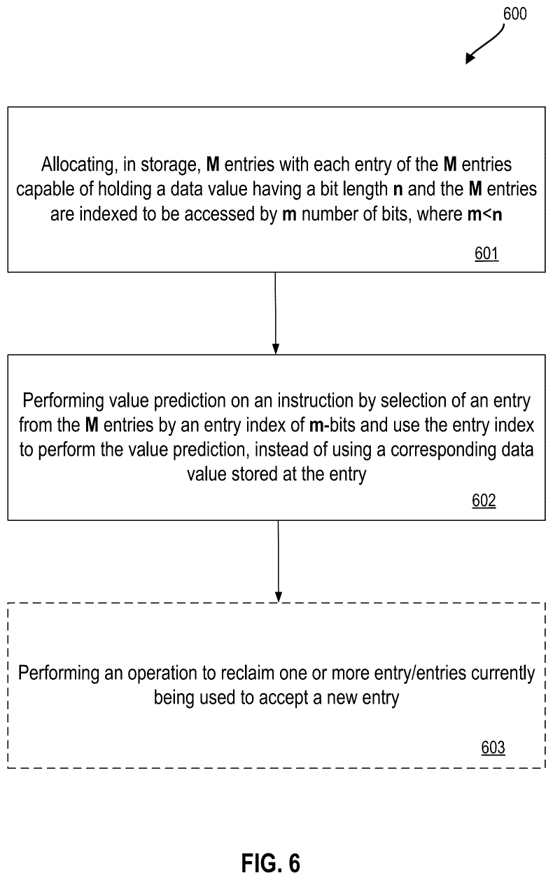

FIG. 6 shows a flow chart showing a method 600 of using the dictionary to perform value prediction according to some examples of the disclosure. Operations 601 and 602 of the method 600 can be performed by a processor, such as the processor 300. In operation 601, a processor (such as processor 300) allocates, in storage, M entries with each entry of the M entries capable of holding a data value having a bit length n and the M entries are indexed to be accessed by m number of bits, where m<n. As an examples with the processor 300 of FIG. 3, the dictionary 101 provides the storage for the M entries to store data values of bit length n, but utilizes the dictionary ID 103 of bit length m for indexing of a dictionary entry as described in FIG. 1 and FIG. 2.

In operation 602, the processor performs value prediction on an instruction by selection of an entry from the M entries by an entry index of m-bits and use the entry index to perform the value prediction, instead of using a corresponding data value stored at the entry. As an example with the processor 300, a value predictor 310 can perform this value prediction.

In an added operation 603, the processor can perform an operation to reclaim one or more entry/entries, of the M entries, currently being used in order to accept a new entry to be stored and used for value prediction. As an example, the state diagram shown in FIG. 4 can be implemented, in which the dictionary valid array and reclaim logic 320 and the dictionary and control logic 308 operate to perform the reclaim.

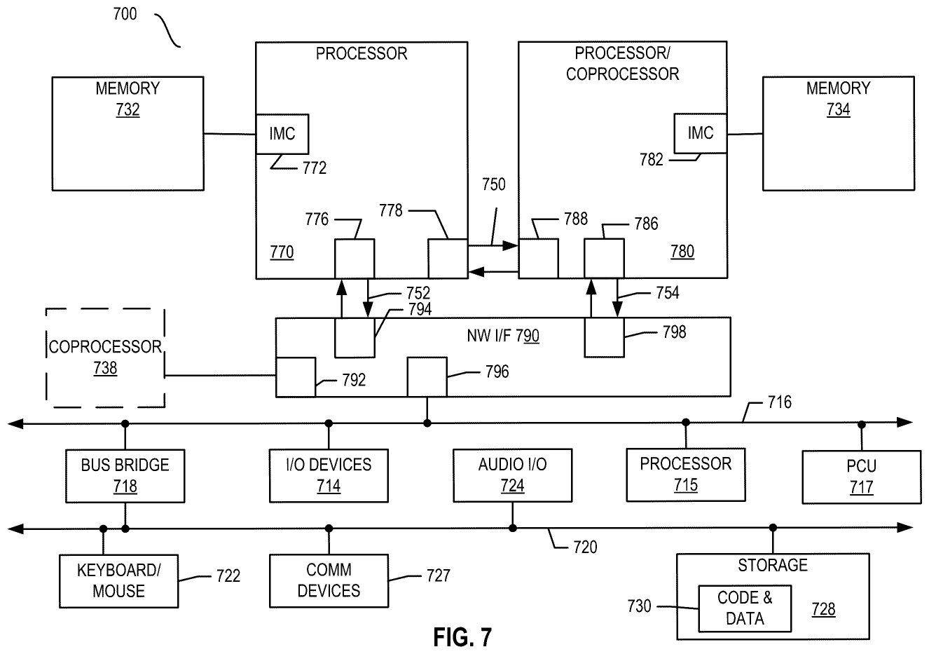

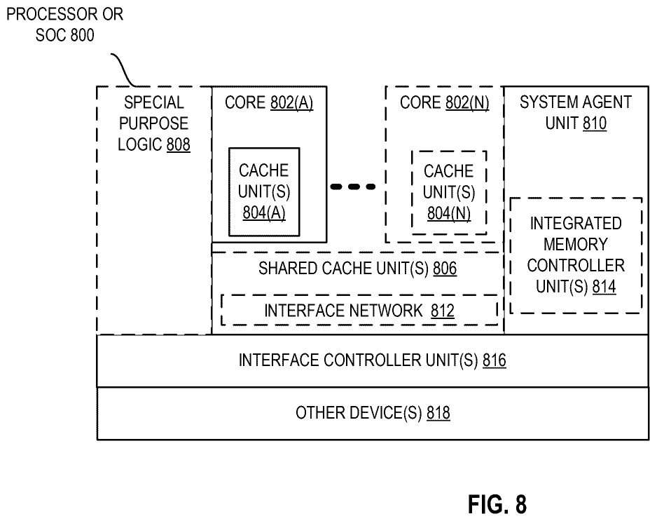

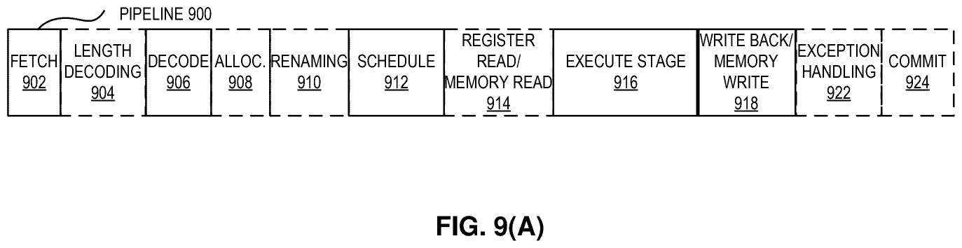

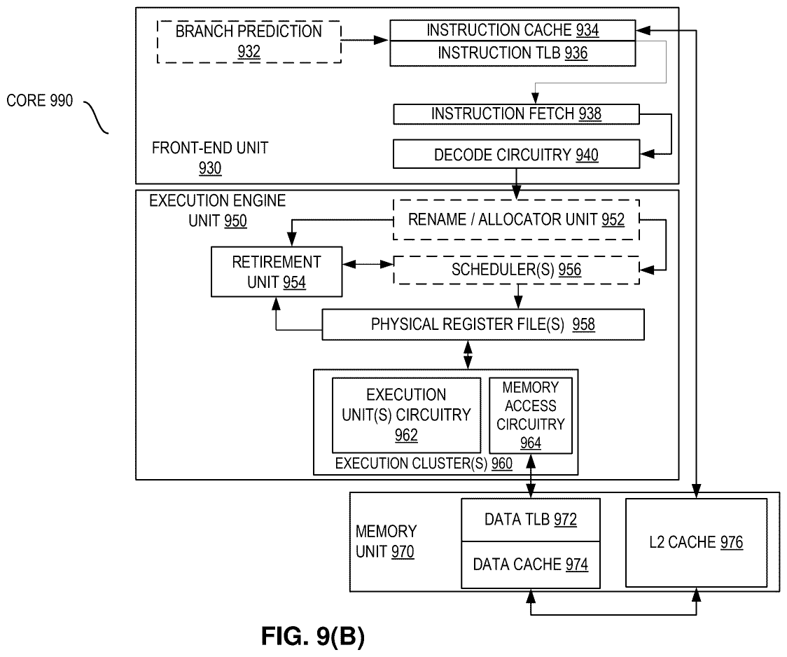

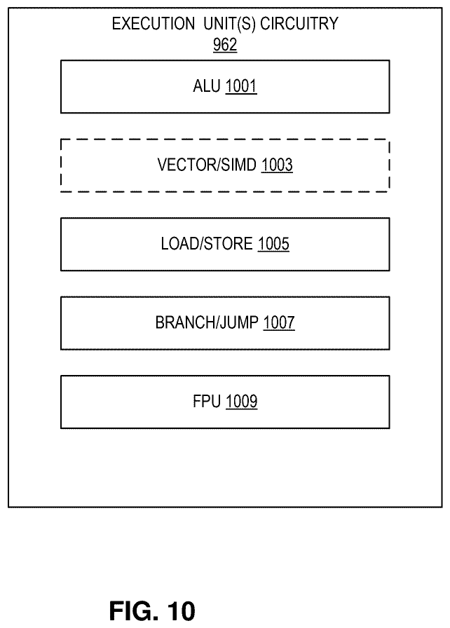

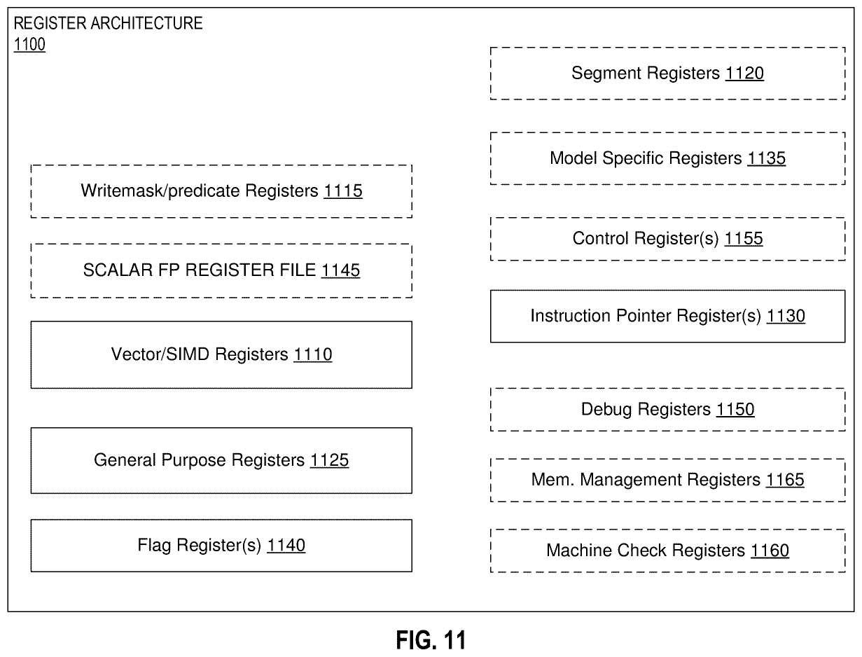

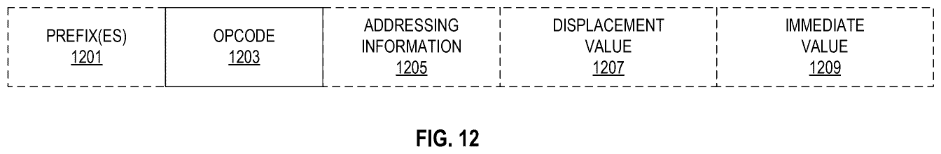

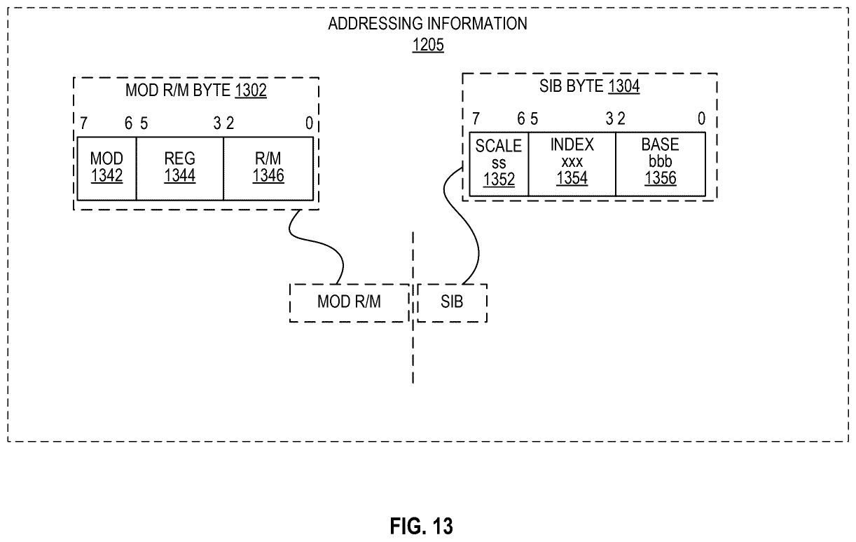

Although the disclosure describes some examples above, other techniques can implement the same or equivalent techniques described. The processor 300 can be implemented in a processor or coprocessor shown in FIG. 7 and FIG. 8. FIG. 9A shows a pipeline that can be duplicated in a processor, including the processor 300. FIG. 9B shows an example utilization of a branch prediction circuitry 932 in a front-end unit 930, along with an execution engine unit 950 to perform the above described operations. FIG. 10 shows another example of an execution unit to perform the functions of the execution unit 305. FIG. 11 shows a register architecture that can perform the functions of the allocation/register rename unit 303. FIG. 12 and FIG. 13 show an instruction format and addressing information which can be used for the instructions, in which value prediction is applied.

### Example Systems

FIG. 7 illustrates an example computing system. Multiprocessor system 700 is an interfaced system and includes a plurality of processors or cores including a first processor 770 and a second processor 780 coupled via an interface 750 such as a point-to-point (P-P) interconnect, a fabric, and/or bus. In some examples, the first processor 770 and the second processor 780 are homogeneous. In some examples, first processor 770 and the second processor 780 are heterogenous. Though the example multiprocessor system 700 is shown to have two processors, the system may have three or more processors, or may be a single processor system. In some examples, the computing system is a system on a chip (SoC).

Processors 770 and 780 are shown including integrated memory controller (IMC) circuitry 772 and 782, respectively. Processor 770 also includes interface circuits 776 and 778; similarly, second processor 780 includes interface circuits 786 and 788. Processors 770, 780 may exchange information via the interface 750 using interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a network interface (NW I/F) 790 via individual interfaces 752, 754 using interface circuits 776, 794, 786, 798. The network interface 790 (e.g., one or more of an interconnect, bus, and/or fabric, and in some examples is a chipset) may optionally exchange information with a co-processor 738 via an interface circuit 792. In some examples, the co-processor 738 is a special-purpose processor, such as, for example, a high-throughput processor, a network or communication processor, a compression engine, a graphics processor, a general purpose graphics processing unit (GPGPU), a neural-network processing unit (NPU), an embedded processor, a security processor, a cryptographic accelerator, a matrix accelerator, an in-memory analytics accelerator,, a data streaming accelerator, data graph operations, or the like.

A shared cache (not shown) may be included in either processor 770, 780 or outside of both processors, yet connected with the processors via an interface such as P-P interconnect, such that either or both processors'local cache information may be stored in the shared cache if a processor is placed into a low power mode.

Network interface 790 may be coupled to a first interface 716 via interface circuit 796. In some examples, first interface 716 may be an interface such as a Peripheral Component Interconnect (PCI) interconnect, a PCI Express interconnect or another I/O interconnect. In some examples, first interface 716 is coupled to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interface 716, along with a bus bridge 718 which couples first interface 716 to a second interface 720. In some examples, one or more additional processor(s) 715, such as co-processors, high throughput many integrated core (MIC) processors, GPGPUs, accelerators (such as graphics accelerators or digital signal processing (DSP) units), field programmable gate arrays (FPGAs), or any other processor, are coupled to first interface 716. In some examples, second interface 720 may be a low pin count (LPC) interface. Various devices may be coupled to second interface 720 including, for example, a keyboard and/or mouse 722, communication devices 727 and storage circuitry 728. Storage circuitry 728 may be one or more non-transitory machine-readable storage media as described below, such as a disk drive or other mass storage device which may include instructions/code and data 730 in some examples. Further, an audio I/O 724 may be coupled to second interface 720. Note that other architectures than the point-to-point architecture described above are possible. For example, instead of the point-to-point architecture, a system such as multiprocessor system 700 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a co-processor including one or more special purpose cores intended primarily for graphics and/or scientific (throughput) computing. Such different processors lead to different computer system architectures, which may include: 1) the co-processor on a separate chip from the CPU; 2) the co-processor on a separate die in the same package as a CPU; 3) the co-processor on the same die as a CPU (in which case, such a co-processor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described co-processor, and additional functionality. Example core architectures are described next, followed by descriptions of example processors and computer architectures.

FIG. 8 illustrates a block diagram of an example processor and/or SoC 800 that may have one or more cores and an integrated memory controller. The solid lined boxes illustrate a processor and/or SoC 800 with a single core 802(A), system agent unit circuitry 810, and a set of one or more interface controller unit(s) circuitry 816, while the optional addition of the dashed lined boxes illustrates an alternative processor and/or SoC 800 with multiple cores 802(A)-(N), a set of one or more integrated memory controller unit(s) circuitry 814 in the system agent unit circuitry 810, and special purpose logic 808, as well as a set of one or more interface controller unit(s) circuitry 816. Note that the processor and/or SoC 800 may be one of the processors 770 or 780, or co-processor 738 or 715 of FIG. 7.

Thus, different implementations of the processor and/or SoC 800 may include: 1) a CPU with the special purpose logic 808 being a high-throughput processor, a network or communication processor, a compression engine, a graphics processor, a general purpose graphics processing unit (GPGPU), a neural-network processing unit (NPU), an embedded processor, a security processor, a matrix accelerator, an in-memory analytics accelerator, a compression accelerator, a data streaming accelerator, data graph operations, or the like(which may include one or more cores, not shown), and the cores 802(A)-(N) being one or more general purpose cores (e.g., general purpose in-order cores, general purpose out-of-order cores, or a combination of the two); 2) a co-processor with the cores 802(A)-(N) being a large number of special purpose cores intended primarily for graphics and/or scientific (throughput); and 3) a co-processor with the cores 802(A)-(N) being a large number of general purpose in-order cores. Thus, the processor and/or SoC 800 may be a general-purpose processor, co-processor or special-purpose processor, such as, for example, a network or communication processor, compression engine, graphics processor, GPGPU (general purpose graphics processing unit), a high throughput many integrated core (MIC) co-processor (including 30 or more cores), embedded processor, or the like. The processor may be implemented on one or more chips. The processor and/or SoC 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804(A)-(N) within the cores 802(A)-(N), a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2 ), level 3 (L3 ), level 4 (L4 ), or other levels of cache, such as a last level cache (LLC), and/or combinations thereof. While in some examples interface network circuitry 812 (e.g., a ring interconnect) interfaces the special purpose logic 808 (e.g., integrated graphics logic), the set of shared cache unit(s) circuitry 806, and the system agent unit circuitry 810, alternative examples use any number of well-known techniques for interfacing such units. In some examples, coherency is maintained between one or more of the shared cache unit(s) circuitry 806 and cores 802(A)-(N). In some examples, interface controller unit(s) circuitry 816 couple the cores 802(A)-(N) to one or more other devices 818 such as one or more I/O devices, storage, one or more communication devices (e.g., wireless networking, wired networking, etc.), etc.

In some examples, one or more of the cores 802(A)-(N) are capable of multi-threading. The system agent unit circuitry 810 includes those components coordinating and operating cores 802(A)-(N). The system agent unit circuitry 810 may include, for example, power control unit (PCU) circuitry and/or display unit circuitry (not shown). The PCU may be or may include logic and components needed for regulating the power state of the cores 802(A)-(N) and/or the special purpose logic 808 (e.g., integrated graphics logic). The display unit circuitry is for driving one or more externally connected displays.

The cores 802(A)-(N) may be homogenous in terms of instruction set architecture (ISA). Alternatively, the cores 802(A)-(N) may be heterogeneous in terms of ISA; that is, a subset of the cores 802(A)-(N) may be capable of executing an ISA, while other cores may be capable of executing only a subset of that ISA or another ISA.

### Example Core Architectures—In-order and Out-of-Order Core Block Diagram

FIG. 9(A) is a block diagram illustrating both an example in-order pipeline and an example register renaming, out-of-order issue/execution pipeline according to examples. FIG. 9(B) is a block diagram illustrating both an example in-order architecture core and an example register renaming, out-of-order issue/execution architecture core to be included in a processor according to examples. The solid lined boxes in FIG. 9(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9(A), a processor pipeline 900 includes a fetch stage 902, an optional length decoding stage 904, a decode stage 906, an optional allocation (Alloc) stage 908, an optional renaming stage 910, a schedule (also known as a dispatch or issue) stage 912, an optional register read/memory read stage 914, an execute stage 916, a write back/memory write stage 918, an optional exception handling stage 922, and an optional commit stage 924. One or more operations can be performed in each of these processor pipeline stages. For example, during the fetch stage 902, one or more instructions are fetched from instruction memory, and during the decode stage 906, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 906 and the register read/memory read stage 914 may be combined into one pipeline stage. In some examples, during the execute stage 916, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 9(B) may implement the pipeline 900 as follows: 1) the instruction fetch circuitry 938 performs the fetch and length decoding stages 902 and 904; 2) the decode circuitry 940 performs the decode stage 906; 3) the rename/allocator unit circuitry 952 performs the allocation stage 908 and renaming stage 910; 4) the scheduler(s) circuitry 956 performs the schedule stage 912; 5) the physical register file(s) circuitry 958 and the memory unit circuitry 970 perform the register read/memory read stage 914; the execution cluster(s) 960 perform the execute stage 916; 6) the memory unit circuitry 970 and the physical register file(s) circuitry 958 perform the write back/memory write stage 918; 7) various circuitry may be involved in the exception handling stage 922; and 8) the retirement unit circuitry 954 and the physical register file(s) circuitry 958 perform the commit stage 924.

FIG. 9(B) shows a processor core 990 including front-end unit circuitry 930 coupled to execution engine unit circuitry 950, and both are coupled to memory unit circuitry 970. The core 990 may be a reduced instruction set architecture computing (RISC) core, a complex instruction set architecture computing (CISC) core, a very long instruction word (VLIW) core, or a hybrid or alternative core type. As yet another option, the core 990 may be a special-purpose core, such as, for example, a network or communication core, compression engine, co-processor core, general purpose computing graphics processing unit (GPGPU) core, graphics core, or the like.

The front-end unit circuitry 930 may include branch prediction circuitry 932 coupled to instruction cache circuitry 934, which is coupled to an instruction translation lookaside buffer (TLB) 936, which is coupled to instruction fetch circuitry 938, which is coupled to decode circuitry 940. In some examples, the instruction cache circuitry 934 is included in the memory unit circuitry 970 rather than the front-end unit circuitry 930. The decode circuitry 940 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 940 may further include address generation unit (AGU, not shown) circuitry. In some examples, the AGU generates an LSU address using forwarded register ports, and may further perform branch forwarding (e.g., immediate offset branch forwarding, LR register branch forwarding, etc.). The decode circuitry 940 may be implemented using various different mechanisms. Examples of suitable mechanisms include, but are not limited to, look-up tables, hardware implementations, programmable logic arrays (PLAs), microcode read only memories (ROMs), etc. In some examples, the core 990 includes a microcode ROM (not shown) or other medium that stores microcode for certain macroinstructions (e.g., in decode circuitry 940 or otherwise within the front-end unit circuitry 930). In some examples, the decode circuitry 940 includes a micro-operation (micro-op) or operation cache (not shown) to hold/cache decoded operations, micro-tags, or micro-operations generated during the decode or other stages of the processor pipeline 900. The decode circuitry 940 may be coupled to rename/allocator unit circuitry 952 in the execution engine unit circuitry 950.

The execution engine unit circuitry 950 includes the rename/allocator unit circuitry 952 coupled to retirement unit circuitry 954 and a set of one or more scheduler(s) circuitry 956. The scheduler(s) circuitry 956 represents any number of different schedulers, including reservations stations, central instruction window, etc. In some examples, the scheduler(s) circuitry 956 can include arithmetic logic unit (ALU) scheduler/scheduling circuitry, ALU queues, address generation unit (AGU) scheduler/scheduling circuitry, AGU queues, etc. The scheduler(s) circuitry 956 is coupled to the physical register file(s) circuitry 958. Each of the physical register file(s) circuitry 958 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 958 includes vector registers unit circuitry, writemask registers unit circuitry, and scalar register unit circuitry. These register units may provide architectural vector registers, vector mask registers, general-purpose registers, etc. The physical register file(s) circuitry 958 is coupled to the retirement unit circuitry 954 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 954 and the physical register file(s) circuitry 958 are coupled to the execution cluster(s) 960. The execution cluster(s) 960 includes a set of one or more execution unit(s) circuitry 962 and a set of one or more memory access circuitry 964. The execution unit(s) circuitry 962 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). In some examples, execution unit(s) circuitry 962 may include hardware to support functionality for instructions for one or more of a compression engine, graphics processing, neural-network processing, in-memory analytics, matrix operations, cryptographic operations, data streaming operations, data graph operations, etc.

While some examples may include a number of execution units or execution unit circuitry dedicated to specific functions or sets of functions, other examples may include only one execution unit circuitry or multiple execution units/execution unit circuitry that all perform all functions. The scheduler(s) circuitry 956, physical register file(s) circuitry 958, and execution cluster(s) 960 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 964). It should also be understood that where separate pipelines are used, one or more of these pipelines may be out-of-order issue/execution and the rest in-order.

In some examples, the execution engine unit circuitry 950 may perform load store unit (LSU) address/data pipelining to an Advanced Microcontroller Bus (AMB) interface (not shown), and address phase and writeback, data phase load, store, and branches.

The set of memory access circuitry 964 is coupled to the memory unit circuitry 970, which includes data TLB circuitry 972 coupled to data cache circuitry 974 coupled to level 2 (L2) cache circuitry 976. In some examples, the memory access circuitry 964 may include load unit circuitry, store address unit circuitry, and store data unit circuitry, each of which is coupled to the data TLB circuitry 972 in the memory unit circuitry 970. The instruction cache circuitry 934 is further coupled to the level 2 (L2) cache circuitry 976 in the memory unit circuitry 970. In some examples, the instruction cache 934 and the data cache 974 are combined into a single instruction and data cache (not shown) in L2 cache circuitry 976, level 3 (L3 ) cache circuitry (not shown), and/or main memory. The L2 cache circuitry 976 is coupled to one or more other levels of cache and eventually to a main memory.

The core 990 may support one or more instructions sets (e.g., the x86 instruction set architecture (optionally with some extensions that have been added with newer versions); the MIPS instruction set architecture; the ARM instruction set architecture (optionally with optional additional extensions such as NEON, etc.); RISC instruction set architecture), including the instruction(s) described herein. In some examples, the core 990 includes logic to support a packed data instruction set architecture extension (e.g., AVX1, AVX2, AVX512, AMX, etc.), thereby allowing the operations used by many multimedia applications to be performed using packed data.

### Example Execution Unit(s) Circuitry

FIG. 10 illustrates examples of execution unit(s) circuitry, such as execution unit(s) circuitry 962 of FIG. 9(B). As illustrated, execution unit(s) circuitry 962 may include one or more ALU circuits 1001, optional vector/single instruction multiple data (SIMD) circuits 1003, load/store circuits 1005, branch/jump circuits 1007, and/or Floating-point unit (FPU) circuits 1009. ALU circuits 1001 perform integer arithmetic and/or Boolean operations. Vector/SIMD circuits 1003 perform vector/SIMD operations on packed data (such as SIMD/vector registers). Load/store circuits 1005 execute load and store instructions to load data from memory into registers or store from registers to memory. Load/store circuits 1005 may also generate addresses. Branch/jump circuits 1007 cause a branch or jump to a memory address depending on the instruction. FPU circuits 1009 perform floating-point arithmetic. The width of the execution unit(s) circuitry 962 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

FIG. 11 is a block diagram of a register architecture 1100 according to some examples. As illustrated, the register architecture 1100 includes vector/SIMD registers 1110 that vary from 128-bit to 1,024 bits width. In some examples, the vector/SIMD registers 1110 are physically 512-bits and, depending upon the mapping, only some of the lower bits are used. For example, in some examples, the vector/SIMD registers 1110 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1100 includes writemask/predicate registers 1115. For example, in some examples, there are 8 writemask/predicate registers (sometimes called k0 through k7) that are each 16-bit, 32-bit, 64-bit, or 128-bit in size. Writemask/predicate registers 1115 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1115 corresponds to a data element position of the destination. In other examples, the writemask/predicate registers 1115 are scalable and consists of a set number of enable bits for a given vector element (e.g., 8 enable bits per 64-bit vector element).

The register architecture 1100 includes a plurality of general-purpose registers 1125. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1100 includes scalar floating-point (FP) register file 1145 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1140 (e.g., EFLAGS, RFLAGS, etc.) store status and control information for arithmetic, compare, and system operations. For example, the one or more flag registers 1140 may store condition code information such as carry, parity, auxiliary carry, zero, sign, and overflow. In some examples, the one or more flag registers 1140 are called program status and control registers.

Segment registers 1120 contain segment points for use in accessing memory. In some examples, these registers are referenced by the names CS, DS, SS, ES, FS, and GS.

Model specific registers or machine specific registers (MSRs) 1135 control and report on processor performance. Most MSRs 1135 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 1160 consist of control, status, and error reporting MSRs that are used to detect and report on hardware errors. Control register(s) 1155 (e.g., CR0-CR4) determine the operating mode of a processor (e.g., processor 770, 780, 738, 715, and/or 800) and the characteristics of a currently executing task. In some examples, MSRs 1135 are a subset of control registers 1155.

One or more instruction pointer register(s) 1130 store an instruction pointer value. Debug registers 1150 control and allow for the monitoring of a processor or core's debugging operations.

Memory (mem) management registers 1165 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1100 may, for example, be used in register file/memory, or physical register file(s) circuitry 9 58.

### Instruction Set Architectures

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

FIG. 12 illustrates examples of an instruction format. As illustrated, an instruction may include multiple components including, but not limited to, one or more fields for: one or more prefixes, an opcode, addressing information (e.g., register identifiers, memory addressing information, etc.), a displacement value, and/or an immediate value. Note that some instructions utilize some or all the fields of the format whereas others may only use the field for the opcode 1203. In some examples, the order illustrated is the order in which these fields are to be encoded, however, it should be appreciated that in other examples these fields may be encoded in a different order, combined, etc.

The prefix(es) 1201, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1203 is used to at least partially define the operation to be performed upon a decoding of the instruction. In some examples, a primary opcode encoded in the opcode field 1203 is one, two, or three bytes in length. In other examples, a primary opcode can be a different length. An additional 3-bit opcode field is sometimes encoded in another field.

The addressing information field 1205 is used to address one or more operands of the instruction, such as a location in memory or one or more registers. FIG. 13 illustrates examples of the addressing information field 1205. In this illustration, an optional MOD R/M byte 1302 and an optional Scale, Index, Base (SIB) byte 1304 are shown. The MOD R/M byte 1302 and the SIB byte 1304 are used to encode up to two operands of an instruction, each of which is a direct register or effective memory address. Note that both of these fields are optional in that not all instructions include one or more of these fields. The MOD R/M byte 1302 includes a MOD field 1342, a register (reg) field 1344, and R/M field 1346.

The content of the MOD field 1342 distinguishes between memory access and non-memory access modes. In some examples, when the MOD field 1342 has a binary value of 11 (11b), a register-direct addressing mode is utilized, and otherwise a register-indirect addressing mode is used.

The register field 1344 may encode either the destination register operand or a source register operand or may encode an opcode extension and not be used to encode any instruction operand. The content of register field 1344, directly or through address generation, specifies the locations of a source or destination operand (either in a register or in memory). In some examples, the register field 1344 is supplemented with an additional bit from a prefix (e.g., prefix 1201) to allow for greater addressing.

The R/M field 1346 may be used to encode an instruction operand that references a memory address or may be used to encode either the destination register operand or a source register operand. Note the R/M field 1346 may be combined with the MOD field 1342 to dictate an addressing mode in some examples.

The SIB byte 1304 includes a scale field 1352, an index field 1354, and a base field 1356 to be used in the generation of an address. The scale field 1352 indicates a scaling factor. The index field 1354 specifies an index register to use. In some examples, the index field 1354 is supplemented with an additional bit from a prefix (e.g., prefix 1201) to allow for greater addressing. The base field 1356 specifies a base register to use. In some examples, the base field 1356 is supplemented with an additional bit from a prefix (e.g., prefix 1201) to allow for greater addressing. In practice, the content of the scale field 1352 allows for the scaling of the content of the index field 1354 for memory address generation (e.g., for address generation that uses 2scale*index+base).

Some addressing forms utilize a displacement value to generate a memory address. For example, a memory address may be generated according to 2scale*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1207 provides this value. Additionally, in some examples, a displacement factor usage is encoded in the MOD field of the addressing information field 1205 that indicates a compressed displacement scheme for which a displacement value is calculated and stored in the displacement field 1207.

In some examples, the immediate value field 1209 specifies an immediate value for the instruction. An immediate value may be encoded as a 1-byte value, a 2-byte value, a 4-byte value, etc.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Furthermore, the disclosure describes various examples in detail as noted above. Further examples are noted below:

Example 1. A processor comprising:
a storage unit containing M entries with each entry of the M entries capable of holding a data value having a bit length n and the M entries are indexed to be accessed by m number of bits, where m<n; and
a value prediction circuitry to perform value prediction on an instruction by selection of an entry from the M entries by an entry index of m-bits and use the entry index to perform the value prediction, instead of using a corresponding data value stored at the entry.

Example 2. The processor according to Example 1, further to retrieve the data value at execution of the instruction, when performing a load operation to verify a load value, or both.

Example 3. The processor according to any one of Examples 1-2 further comprising a validity and reclaim logic to validate, invalidate and reclaim one or more entries of the M entries in the storage unit.

Example 4. The processor according to any one of Examples 1-3, wherein the validity and reclaim logic indicates:
an invalid entry when a corresponding entry does not have a valid data value stored therein, wherein a new data value is permitted to be stored in the corresponding entry;
a valid entry when a corresponding entry has a valid data value stored therein, wherein the valid data value is not to change until the corresponding entry is reclaimed; and
a pending reclaim when a corresponding entry is being reclaimed for use with another data value, wherein the corresponding entry is disallowed for use in new predictions and reclaimed when there are no pending use of a current data value of the corresponding entry for use in prediction remaining, in which when the corresponding entry is reclaimed, the corresponding entry is placed into an invalid state to accept the new data value.

Example 5. The processor according to any one of Examples 1-4, wherein the validity and reclaim logic to reclaim a valid indicated entry location for the new data value by operations to:
receive a request to reclaim a least recently used entry as a candidate entry for reclaiming;
determine if the candidate entry is currently used in a register alias table, wherein when yes, to reject the request to reclaim;
determine if a reorder buffer identity for the candidate entry has been cleared for misprediction or exception, wherein when yes, to reject the request to reclaim; and
determine if the reorder buffer identity has been retired, wherein if yes, to accept the request to reclaim.

Example 6. The processor according to any one of Examples 1-5, wherein the storage unit maintains a threshold level of entries with invalid states for use in storing new data values by sending a request to the validity and reclaim logic to reclaim a currently valid entry location when a number of entries with invalid states falls below the threshold level.

Example 7. The processor according to any one of Examples 1-6, wherein the M entries contain both fixed data values and variable data values.

Example 8. The processor according to any one of Examples 1-7, wherein M=64, n=64 and m=6.

Example 9. A method comprising:
allocating, in storage, M entries with each entry of the M entries capable of holding a data value having a bit length n and the M entries are indexed to be accessed by m number of bits, where m<n; and
performing value prediction on an instruction by selection of an entry from the M entries by an entry index of m-bits and use the entry index to perform the value prediction, instead of using a corresponding data value stored at the entry.

Example 10. The method according to Example 9, further comprising retrieving the data value at execution of the instruction, when performing a load operation to verify a load value, or both.

Example 11. The method according to any one of Examples 9-10 further comprising indicating valid, invalid and pending reclaim states for one or more entries of the M entries in the storage.

Example 12. The method according to any one of Examples 9-11, further comprising:
indicating an invalid entry when a corresponding entry does not have a valid data value stored therein, wherein a new data value is permitted to be stored in the corresponding entry;
indicating a valid entry when a corresponding entry has a valid data value stored therein, wherein the valid data value is not to change until the corresponding entry is reclaimed; and
indicating a pending reclaim when a corresponding entry is being reclaimed for use with another data value, wherein the corresponding entry is disallowed for use in new predictions and reclaimed when there are no pending use of a current data value of the corresponding entry for use in prediction remaining, in which when the corresponding entry is reclaimed, the corresponding entry is placed into an invalid state to accept the new data value.

Example 13. The method according to any one of Examples 9-12, further comprising reclaiming a valid indicated entry location for the new data value by performing operations comprising:
receiving a request to reclaim a least recently used entry as a candidate entry for reclaiming;
determining if the candidate entry is currently used in a register alias table, wherein when yes, rejecting the request to reclaim;
determining if a reorder buffer identity for the candidate entry has been cleared for misprediction or exception, wherein when yes, rejecting the request to reclaim; and
determining if the reorder buffer identity has been retired, wherein if yes, accepting the request to reclaim.

Example 14. The method according to any one of Examples 9-13, further comprising maintaining a threshold level of entries with invalid states for use in storing new data values by performing operations to reclaim a currently valid entry location when a number of entries with invalid states falls below the threshold level.

Example 15. A system comprising:
a storage unit containing M entries with each entry of the M entries capable of holding a data value having a bit length n and the M entries are indexed to be accessed by m number of bits, where m<n;
a value prediction circuitry to perform value prediction on an instruction by selection of an entry from the M entries by an entry index of m-bits and use the entry index to perform the value prediction, instead of using a corresponding data value stored at the entry;
a validity and reclaim logic to validate, invalidate and reclaim one or more entries of the M entries in the storage unit; and
a load unit to access the entry to perform a verification of a predicted load value to the data value stored at the entry.

Example 16. The system according to Example 15, further comprising an execution unit to access the entry to perform a verification of a predicted source value of the instruction to the data value stored at the entry to execute the instruction.

Example 17. The system according to any one of Examples 15-16, wherein M entries of the storage unit are duplicated at one or more locations proximal to operational units that need to access the M entries to compare a predicted value to a corresponding data value entry, wherein the operational units access a corresponding proximal duplicated location entry instead of accessing the storage unit.

Example 18. The system according to any one of Examples 15-17, wherein the validity and reclaim logic indicates:
an invalid entry when a corresponding entry does not have a valid data value stored therein, wherein a new data value is permitted to be stored in the corresponding entry;
a valid entry when a corresponding entry has a valid data value stored therein, wherein the valid data value is not to change until the corresponding entry is reclaimed; and
a pending reclaim when a corresponding entry is being reclaimed for use with another data value, wherein the corresponding entry is disallowed for use in new predictions and reclaimed when there are no pending use of a current data value of the corresponding entry for use in prediction remaining, in which when the corresponding entry is reclaimed, the corresponding entry is placed into an invalid state to accept the new data value.

Example 19. The system according to any one of Examples 15-18, wherein the validity and reclaim logic to reclaim a valid indicated entry location for the new data value by performing operations to:
receive a request to reclaim a least recently used entry as a candidate entry for reclaiming;
determine if the candidate entry is currently used in a register alias table, wherein when yes, to reject the request to reclaim;
determine if a reorder buffer identity for the candidate entry has been cleared for misprediction or exception, wherein when yes, to reject the request to reclaim; and
determine if the reorder buffer identity has been retired, wherein if yes, to accept the request to reclaim.

Example 20. The system according to any one of Examples 15-19, wherein the storage unit maintains a threshold level of entries with invalid states for use in storing new data values by sending a request to the validity and reclaim logic to reclaim a currently valid entry location when a number of entries with invalid states falls below the threshold level.

What is claimed is:

1. A processor comprising:
a storage unit containing M entries with each entry of the M entries capable of holding a data value having a bit length n and the M entries are indexed to be accessed by m number of bits, where m<n; and
a value prediction circuitry to perform value prediction on an instruction by selection of an entry from the M entries by an entry index of m-bits and use the entry index to perform the value prediction, instead of using a corresponding data value stored at the entry.

2. The processor according to claim 1, further to retrieve the data value at execution of the instruction, when performing a load operation to verify a load value, or both.

3. The processor according to claim 1 further comprising a validity and reclaim logic to validate, invalidate and reclaim one or more entries of the M entries in the storage unit.

4. The processor according to claim 3, wherein the validity and reclaim logic indicates:
an invalid entry when a corresponding entry does not have a valid data value stored therein, wherein a new data value is permitted to be stored in the corresponding entry;
a valid entry when a corresponding entry has a valid data value stored therein, wherein the valid data value is not to change until the corresponding entry is reclaimed; and
a pending reclaim when a corresponding entry is being reclaimed for use with another data value, wherein the corresponding entry is disallowed for use in new predictions and reclaimed when there are no pending use of a current data value of the corresponding entry for use in prediction remaining, in which when the corresponding entry is reclaimed, the corresponding entry is placed into an invalid state to accept the new data value.

5. The processor according to claim 4, wherein the validity and reclaim logic to reclaim a valid indicated entry location for the new data value by operations to:
receive a request to reclaim a least recently used entry as a candidate entry for reclaiming;
determine if the candidate entry is currently used in a register alias table, wherein when yes, to reject the request to reclaim;
determine if a reorder buffer identity for the candidate entry has been cleared for misprediction or exception, wherein when yes, to reject the request to reclaim; and
determine if the reorder buffer identity has been retired, wherein if yes, to accept the request to reclaim.

6. The processor according to claim 5, wherein the storage unit maintains a threshold level of entries with invalid states for use in storing new data values by sending a request to the validity and reclaim logic to reclaim a currently valid entry location when a number of entries with invalid states falls below the threshold level.

7. The processor according to claim 1, wherein the M entries contain both fixed data values and variable data values.

8. The processor according to claim 1, wherein M=64, n=64 and m=6.

9. A method comprising:
allocating, in storage, M entries with each entry of the M entries capable of holding a data value having a bit length n and the M entries are indexed to be accessed by m number of bits, where m<n; and
performing value prediction on an instruction by selection of an entry from the M entries by an entry index of m-bits and use the entry index to perform the value prediction, instead of using a corresponding data value stored at the entry.

10. The method according to claim 9, further comprising retrieving the data value at execution of the instruction, when performing a load operation to verify a load value, or both.

11. The method according to claim 9 further comprising indicating valid, invalid and pending reclaim states for one or more entries of the M entries in the storage.

12. The method according to claim 11, further comprising:
indicating an invalid entry when a corresponding entry does not have a valid data value stored therein, wherein a new data value is permitted to be stored in the corresponding entry;
indicating a valid entry when a corresponding entry has a valid data value stored therein, wherein the valid data value is not to change until the corresponding entry is reclaimed; and
indicating a pending reclaim when a corresponding entry is being reclaimed for use with another data value, wherein the corresponding entry is disallowed for use in new predictions and reclaimed when there are no pending use of a current data value of the corresponding entry for use in prediction remaining, in which when the corresponding entry is reclaimed, the corresponding entry is placed into an invalid state to accept the new data value.

13. The method according to claim 12, further comprising reclaiming a valid indicated entry location for the new data value by performing operations comprising:
receiving a request to reclaim a least recently used entry as a candidate entry for reclaiming;
determining if the candidate entry is currently used in a register alias table, wherein when yes, rejecting the request to reclaim;
determining if a reorder buffer identity for the candidate entry has been cleared for misprediction or exception, wherein when yes, rejecting the request to reclaim; and
determining if the reorder buffer identity has been retired, wherein if yes, accepting the request to reclaim.

14. The method according to claim 13, further comprising maintaining a threshold level of entries with invalid states for use in storing new data values by performing operations to reclaim a currently valid entry location when a number of entries with invalid states falls below the threshold level.

15. A system comprising:
a storage unit containing M entries with each entry of the M entries capable of holding a data value having a bit length n and the M entries are indexed to be accessed by m number of bits, where m<n;
a value prediction circuitry to perform value prediction on an instruction by selection of an entry from the M entries by an entry index of m-bits and use the entry index to perform the value prediction, instead of using a corresponding data value stored at the entry;
a validity and reclaim logic to validate, invalidate and reclaim one or more entries of the M entries in the storage unit; and
a load unit to access the entry to perform a verification of a predicted load value to the data value stored at the entry.

16. The system according to claim 15, further comprising an execution unit to access the entry to perform a verification of a predicted source value of the instruction to the data value stored at the entry to execute the instruction.

17. The system according to claim 16, wherein M entries of the storage unit are duplicated at one or more locations proximal to operational units that need to access the M entries to compare a predicted value to a corresponding data value entry, wherein the operational units access a corresponding proximal duplicated location entry instead of accessing the storage unit.

18. The system according to claim 16, wherein the validity and reclaim logic indicates:
an invalid entry when a corresponding entry does not have a valid data value stored therein, wherein a new data value is permitted to be stored in the corresponding entry;
a valid entry when a corresponding entry has a valid data value stored therein, wherein the valid data value is not to change until the corresponding entry is reclaimed; and
a pending reclaim when a corresponding entry is being reclaimed for use with another data value, wherein the corresponding entry is disallowed for use in new predictions and reclaimed when there are no pending use of a current data value of the corresponding entry for use in prediction remaining, in which when the corresponding entry is reclaimed, the corresponding entry is placed into an invalid state to accept the new data value.

19. The system according to claim 18, wherein the validity and reclaim logic to reclaim a valid indicated entry location for the new data value by performing operations to:
receive a request to reclaim a least recently used entry as a candidate entry for reclaiming;
determine if the candidate entry is currently used in a register alias table, wherein when yes, to reject the request to reclaim;
determine if a reorder buffer identity for the candidate entry has been cleared for misprediction or exception, wherein when yes, to reject the request to reclaim; and
determine if the reorder buffer identity has been retired, wherein if yes, to accept the request to reclaim.

20. The system according to claim 19, wherein the storage unit maintains a threshold level of entries with invalid states for use in storing new data values by sending a request to the validity and reclaim logic to reclaim a currently valid entry location when a number of entries with invalid states falls below the threshold level.
